(19) United States
(12) Patent Application Publication
(10) Pub. No.: US 2002/0187694 A1
(43) Pub. Date: Dec. 12, 2002

(54) Mesh reinforced breathable plastic film

(76) Inventors: Thomas B. Brighton, Woodland Hills, UT (US); David A. Bryniarski, Pittsford, NY (US)

Correspondence Address: JENKENS & GILCHRIST, P.C., 225 WEST WASHINGTON, SUITE 2600, CHICAGO, IL, 60606, US

(21) Appl. No.: 09/878,515

(22) Filed: Jun. 11, 2001

(51) Int. Cl. D04B 1/00; D03D 9/00; B32B 27/04; B32B 27/12; B32B 27/32

(52) U.S. Cl. 442/41; 442/1; 442/2; 442/38

(57) ABSTRACT

A mesh reinforced breathable plastic film combines the vapor permeability of breathable plastic films with the strength characteristics of mesh reinforced films. A plastic mesh layer having a netlike structure reinforces a breathable layer. The mesh reinforced breathable plastic film can be used to securely contain items that require vapor to escape during travel or storage.

### FIELD OF THE INVENTION

The present invention relates generally to mesh reinforced films and, more particularly, relates to a breathable plastic film reinforced with a mesh.

### BACKGROUND OF THE INVENTION

Breathable plastic films are well-known in the plastic film industry, and they are commonly used for their ability to allow moisture and air to pass through them while still retaining their ability to contain goods. Breathable films can be quite weak, though, because the qualities that allow gas and vapor to pass through also compromise their strength. This makes them more susceptible than other types of film to tears, warping, and other structural instabilities. This fault has limited breathable plastic films to relatively low-stress uses, though there are several applications where a strong, breathable plastic film would be desirable.

### SUMMARY OF THE INVENTION

Accordingly, an object of the present invention is to provide a mesh reinforced breathable plastic film. Such a film will provide the selective permeability of standard breathable plastic films while also providing the physical strength of sturdier plastic films.

A mesh reinforced breathable plastic film has a layer of breathable plastic film with an attached mesh reinforcement layer. The mesh reinforced breathable plastic film can be manufactured by co-extruding a mesh reinforcement layer and a breathable plastic layer or by extruding the layers separately and then joining them in a lamination process.

One use for a mesh reinforced breathable plastic film is as a lumber overwrap. In the lumber industry, there is a need to unitize lumber and protect it from the elements (including rain, snow, and dirt) while at the same time permitting water vapor to pass from the lumber bundle into the atmosphere. A mesh reinforced breathable plastic film will have the strength to contain lumber for shipment, will be impervious to rain, snow, and dirt, and yet will permit water trapped within the film to “breathe” out as water vapor.

The above summary of the present invention is not intended to represent each embodiment, or every aspect of the present invention. This is the purpose of the following figures and detailed description.

### BRIEF DESCRIPTION OF THE DRAWINGS

In the accompanying drawings:

FIG. 1 is a top view of a mesh reinforced breathable film embodying the present invention; and

FIG. 2 is a sectional view taken generally along line 2-2 in FIG. 1.

While the invention is susceptible to various modifications and alternative forms, a specific embodiment thereof has been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE DRAWINGS

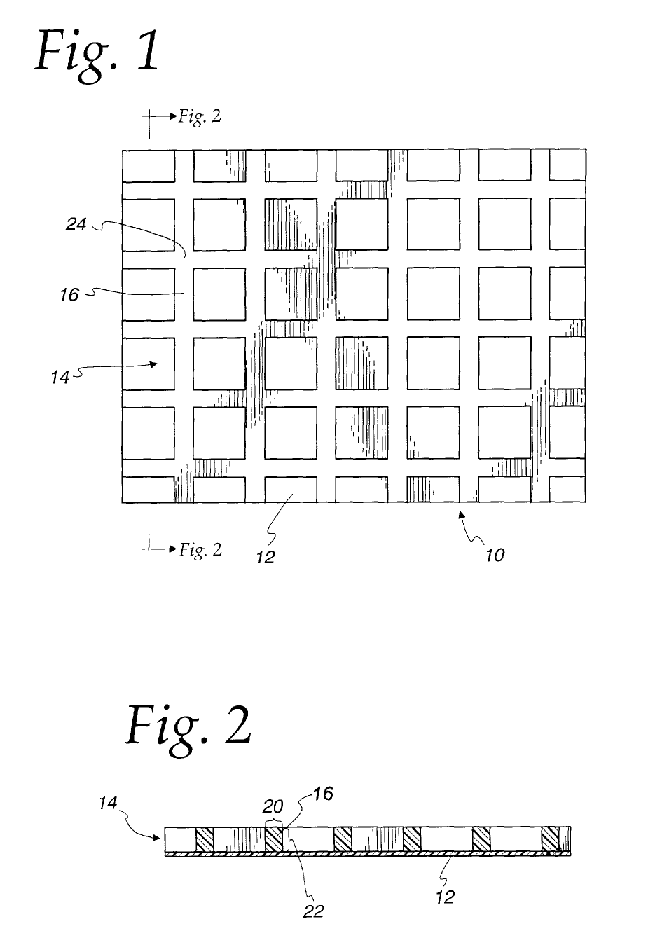

FIG. 1 shows a top view of a mesh reinforced breathable plastic film 10. The mesh reinforced breathable plastic film 10 combines the desirable vapor-permeable qualities of standard breathable films with the strength characteristics of stronger standard films. Mesh reinforced films are also discussed in U.S. patent application Ser. No. 09/510,857 by David A. Bryniarski, filed Feb. 23, 2000 and incorporated herein by reference in its entirety.

The mesh reinforced breathable plastic film 10 consists of a breathable film layer 12 which is in contact with a mesh layer 14. The breathable film layer 12 and mesh layer 14 may be joined directly by co-extrusion during their formation, with both layers being extruded simultaneously. Alternately, the layers can be joined together in a laminating process. In an alternative embodiment, the breathable film layer 12 and the mesh layer 14 may be joined by a layer of adhesive between the two layers. The breathable film layer 12 may be comprised of a variety of polymers, including low density polyethylene (“LDPE”), linear low density polyethylene (“LLDPE”), metallocene linear low density polyethylene (“mLLDPE”), or high density polyethylene (“HDPE”) modified to allow water vapor permeability. The mesh layer 14 may also be comprised of a variety of polymers, including LDPE, LLDPE, mLLDPE, HDPE, polypropylene (“PP”), or polyethylene-polypropylene copolymer (“PE-PP”).

The mesh layer 14 is comprised of mesh strands 16 overlapping or intersecting each other so as to form a netlike structure. A cross-sectional view of mesh strands 16 joined to the breathable film layer 12 is shown in FIG. 2. The strength of the mesh layer 14 arises in part from its netlike structure and also in part from the width and depth of its mesh strands 16. As seen in FIG. 2, mesh strands 16 have a width 20 and a depth 22. In one embodiment of the present invention, the mesh strands 16 have a depth of from approximately 0.005 inches to approximately 0.060 inches and a width of from approximately 0.005 to 0.060 inches. When a mesh layer with mesh strands 16 having these widths and depths is placed atop a breathable film layer having a thickness of from approximately 0.0005 inches to approximately 0.015 inches, the resulting mesh reinforced breathable plastic film is well-suited to many industrial and shipping uses.

The mesh strands 16 meet each other at mesh strand intersections 24. The depth of the mesh at these intersections may be the same as the depth along the lengths of the strands, or the depth may be increased up to double the depth along the strand lengths.

While the present invention has been described with reference to one or more preferred embodiments, those skilled in the art will recognize that many changes may be made thereto without departing from the spirit and scope of the present invention which is set forth in the following claims.

What is claimed is:

1. A mesh reinforced breathable film comprising a breathable film layer and a mesh layer attached to the breathable film layer.

2. The mesh reinforced breathable film of claim 1 wherein the breathable film layer is comprised of a polymer material selected from a group consisting of low density polyethylene, linear low density polyethylene, metallocene linear low density polyethylene and high density polyethylene, the polymer material being modified to allow water vapor permeability.

3. The mesh reinforced breathable film of claim 2 wherein the mesh layer is comprised of a polymer material selected from a group consisting of low density polyethylene, linear low density polyethylene, metallocene linear low density polyethylene, high density polyethylene, polypropylene, and polyethylene-polypropylene copolymer.

4. The mesh reinforced breathable film of claim 1 wherein the breathable film layer has a thickness of from about 0.0005 inches to about 0.015 inches.

5. The mesh reinforced breathable film of claim 1 wherein the mesh layer comprises mesh strands, the mesh strands having a width of from about 0.005 inches to about 0.060 inches and a depth of from about 0.005 inches to about 0.060 inches.

6. A method of forming a mesh reinforced breathable film comprising:
extruding a breathable film layer; and
coextruding a mesh layer with the breathable film layer.

7. The method of claim 6 wherein the breathable film layer is comprised of a polymer material selected from a group consisting of low density polyethylene, linear low density polyethylene, metallocene linear low density polyethylene and high density polyethylene, the polymer material being modified to allow water vapor permeability.

8. The method of claim 6 wherein the mesh layer is comprised of a polymer material selected from a group consisting of low density polyethylene, linear low density polyethylene, metallocene linear low density polyethylene, high density polyethylene, polypropylene, and polyethylene-polypropylene copolymer.

9. The method of claim 6 wherein extruding the breathable film layer includes extruding a breathable film having a thickness of from about 0.0005 inches to about 0.015 inches following extrusion.

10. The method of claim 6 wherein coextruding the mesh layer comprises coextruding a mesh layer having mesh strands, the mesh strands having a width of from about 0.005 inches to about 0.060 inches and a depth of from about 0.005 inches to about 0.060 inches.

11. A method of forming a mesh reinforced breathable film comprising:
forming a breathable film layer;
forming a mesh layer; and
laminating the mesh layer to the breathable film layer.

12. The method of claim 11 wherein the breathable film layer is comprised of a polymer material selected from a group consisting of low density polyethylene, linear low density polyethylene, metallocene linear low density polyethylene and high density polyethylene, the polymer material being modified to allow water vapor permeability.

13. The method of claim 11 wherein the mesh layer is comprised of a polymer material selected from a group consisting of low density polyethylene, linear low density polyethylene, metallocene linear low density polyethylene, high density polyethylene, polypropylene, and polyethylene-polypropylene copolymer.

14. The method of claim 11 wherein forming the breathable film layer includes forming a breathable film having a thickness of from about 0.0005 inches to about 0.015 inches.

15. The method of claim 11 wherein forming the mesh layer comprises forming a mesh layer having mesh strands, the mesh strands having a width of from about 0.005 inches to about 0.060 inches and a depth of from about 0.005 inches to about 0.060 inches.

16. A method of forming a mesh reinforced breathable film comprising:
providing a breathable film layer;
applying adhesive to the breathable film layer; and
overlaying a mesh layer onto the adhesive.

17. The method of claim 16 wherein the breathable film layer is comprised of a polymer material selected from a group consisting of low density polyethylene, linear low density polyethylene, metallocene linear low density polyethylene and high density polyethylene, the polymer material being modified to allow water vapor permeability.

18. The method of claim 16 wherein the mesh layer is comprised of a polymer material selected from a group consisting of low density polyethylene, linear low density polyethylene, metallocene linear low density polyethylene, high density polyethylene, polypropylene, and polyethylene-polypropylene copolymer.

19. The method of claim 16 wherein the breathable film layer has a thickness of from about 0.0005 inches to about 0.015 inches.

20. The method of claim 16 wherein the mesh layer comprises mesh strands having a width of from about 0.005 inches to about 0.060 inches and a depth of from about 0.005 inches to about 0.060 inches.

21. A mesh reinforced breathable film comprising:
a breathable film layer having a thickness of from about 0.0005 inches to about 0.015 inches, the breathable film layer being comprised of a polymer material selected from a group consisting of low density polyethylene, linear low density polyethylene, metallocene linear low density polyethylene and high density polyethylene, the polymer material being modified to allow water vapor permeability;
a mesh layer having mesh strands, the mesh strands having a width of from about 0.005 inches to about 0.060 inches and a depth of from about 0.005 inches to about 0.060 inches, the mesh layer being comprised of a polymer material selected from a group consisting of low density polyethylene, linear low density polyethylene, metallocene linear low density polyethylene, high density polyethylene, polypropylene, and polyethylene-polypropylene copolymer.
